(19) United States
(12) Patent Application Publication
(10) Pub. No.: US 2023/0237978 A1
(43) Pub. Date: Jul. 27, 2023

(54) Apparatus And Method For Stringed Instrument Endpin

(71) Applicant: Christopher Threlkeld-Wiegand, Iowa City, IA (US)

(72) Inventor: Christopher Threlkeld-Wiegand, Iowa City, IA (US)

(21) Appl. No.: 17/803,062

(22) Filed: Jan. 27, 2022

(51) Int. Cl. G10D 3/01; G10D 1/02

(52) U.S. Cl. CPC G10D 3/01; G10D 1/02

(57) ABSTRACT

A stringed instrument endpin includes a post for attachment to a stringed instrument and a recurved leg for supporting the instrument during play. The recurved leg carries the weight of the instrument to a supporting surface, such as a performance hall floor. The endpin may be adjustable about the axis of the post and along the spine of the recurved leg.

### BACKGROUND

Inventive concepts relate generally to an apparatus and method for a stringed instrument endpin. In particular, inventive concepts relate to an apparatus and method for a stringed instrument endpin that may be used to support the instrument and improve the instrument’s performance as its strings are bowed or plucked.

The violin family of stringed musical instruments, including the violin, viola, and cello, was first developed in Italy in the early 1500 s. The general design of such instruments was refined in the 1600 s by such well-known makers as the Amati family and Antonio Stradivari. That design survives substantially intact to this day, with relatively minor modifications, for example, to the length and tilt of the fingerboard and to the length of the neck. There is some debate as to whether the double bass (also referred to herein, simply, as a bass) is derived from the viol or is a member of the violin family. The double bass’s proportions are unlike those of the violin and cello, for example, in that it is proportionately much deeper than a violin and it shoulders are much more sloping than those of the violin. This yields an external appearance more like that of the viola da gamba, but the internal construction of the double bass is nearly identical to that of instruments of the violin family. In any case, all these stringed musical instruments, and more, employ an endpin. An improved endpin in accordance with principles of inventive concepts may be employed to advantage with any stringed musical instrument that requires an endpin and relies upon the endpin for support of the instrument. The cello and bass both rely upon an endpin for support during playing, but, for clarity of illustration and convenience, the following discussion will be substantially limited to example embodiments for a bass. Uses and advantages of an endpin in in accordance with principles of inventive concepts in conjunction with a cello or other stringed instrument should be clear from the following examples of use with a bass.

The general construction of a violin family instrument will now be described in reference to the perspective view of a conventional violin of FIGS. 1A and 1B. As previously noted, an apparatus and method in accordance with principles of inventive concepts may be used in conjunction with any stringed musical instrument that employs an endpin, but most advantageously with a stringed musical instrument that is supported by the endpin while the instrument is played.

An example of a conventional stringed instrument employing an endpin is illustrated in FIGS. 1A and 1B. Although this illustration may apply to any instrument of the violin family of stringed musical instrument, including, cello or bass, for clarity and conciseness of description, the instrument in this general illustration will be referred to, simply, as a violin family instrument. Additionally, as noted above, inventive concepts may be applied to any stringed musical instrument that employs an endpin.

The violin family instrument 100 includes a hollow body 110, neck 120, strings 130, a tailpiece 140 to which ends of strings 130 are fastened, and bridge 150 for transmitting the vibration of the strings 130 to the body 110. The tailpiece 140 attaches, at the opposite end to which the strings are attached, to endpin 119. The term “endpin” is used herein to refer to the element of a stringed instrument, referred to in the violin family of stringed instruments as either an endpin or button and, generally, refers to an element that attaches a gut-end of a tailpiece to the body of the instrument. In some stringed instruments, such as a cello or bass, an endpin 119 may support the instrument 100 while it is being played, the body 110 includes an upper plate 112 in which f-shaped holes 124 are formed and a lower plate 114. Rib 116 connects the upper plate 112 and lower plate 114 to form a hollow resonant body. A portion of rib 116, which is substantially planar and is configured to accept endpin 119 may be referred to herein as lower rib 115.

Four spaced-apart strings 130 are tensioned on the upper plate of the body 110. The ends of the strings 130 opposite the ends attached to the tailpiece 140 are wound to the pegs 122. Four string holes 142 are formed in the tailpiece and the ends of strings 130 are inserted into these holes and fastened to the tailpiece through the holes. Tailgut 126, traditionally formed of gut cord, are wrapped around endpin 119, with one “leg” (that is, strand, length, cord, cable, etc.) on either side of endpin and both legs returning to tailpiece 140 to be fixed to the tailpiece, thereby fastening the tailpiece 140 to the body 110. Vibrations generated in the strings 130, by plucking or bowing for example, may be transmitted by the bridge 150 to the resonant body 110 (including upper or top plate 112, lower or bottom plate 114, and rib 116) for amplification. As will be described in greater detail in the discussions related to the following figures, for instruments supported, at least in part, by endpin 119 during playing, the endpin 119 extends from the lower rib 115, allowing it to contact a performing surface, such as a concert hall floor, without interfering with movement of body 110. In example embodiments an endpin plug 140, such as that illustrated in FIG. 1B, may include an orifice 142 configured to receive an endpin 119 and set screw 144 to tighten the endpin 119 in place.

### SUMMARY OF THE INVENTION

In example embodiments in accordance with principles of inventive concepts a musical instrument endpin includes a post for attachment to a stringed instrument and a recurved leg for supporting the instrument during play. The recurved leg carries the weight of the instrument to a supporting surface, such as a performance hall floor, as the instrument is held upright. The endpin may be adjustable about the axis of the post and along the spine of the recurved leg.

In example embodiments a musical instrument endpin includes a post configured to engage a stringed instrument through the instrument’s sidewall and a recurved leg configured to conduct forces from the post to a supporting surface.

In example embodiments a musical instrument endpin includes a post that post engages the stringed instrument through an endpin collar located in the instrument’s sidewall.

In example embodiments a musical instrument endpin includes a post that is configured to be rotatably adjustable about an axis defined by centerline of the post.

In example embodiments a musical instrument endpin includes a post that is integral to the recurved leg.

In example embodiments a musical instrument endpin includes a post that is configured for attachment to the recurved leg.

In example embodiments a musical instrument endpin includes a post that is configured to be adjustable in position along the recurved leg.

In example embodiments a musical instrument endpin includes a recurved leg that includes a slot for receiving the post.

In example embodiments a musical instrument endpin includes a leg that includes a contact region for contact with a supporting surface.

In example embodiments a musical instrument endpin includes a leg that includes a plurality of contact regions for contact with a supporting floor.

In example embodiments a musical instrument endpin includes a contact region includes a non-skid surface.

In example embodiments a musical instrument endpin includes a contact region that is configured for penetration of the supporting surface.

In example embodiments a musical instrument endpin includes a recurved leg that includes a plurality of recurved regions.

In example embodiments a musical instrument endpin includes a leg in which a recurve region is arcuate.

In example embodiments a musical instrument endpin includes a leg in which a recurve region is angular.

In example embodiments a musical instrument endpin includes a recurved leg in which the recurve region is a combination of arcuate and angular regions.

### BRIEF DESCRIPTION OF THE DRAWINGS

Example embodiments in accordance with principles of inventive concepts will be more clearly understood from the following detailed description taken in conjunction with the accompanying drawings in which:

FIG. 1A is perspective view of a conventional violin family stringed instrument and FIG. 1B is a view of an endpin plug for use in securing an endpin to a stringed instrument;

FIG. 2 is a plan view of an example embodiment of an endpin in accordance with principles of inventive concepts in place on a violin family stringed instrument;

FIG. 3 is a side view of an example embodiment of a stringed instrument endpin in accordance with principles of inventive concepts;

FIGS. 4A and 4B are side views of an example embodiment of an endpin in accordance with principles of inventive concepts attached to a stringed instrument and supported by a supporting surface;

FIGS. 5A, 5B, and 5C are views of an example embodiment of an adjustable endpin in accordance with principles of inventive concepts;

FIGS. 6A, 6B, 6C, and 6D are conceptual views of various endpin configurations in accordance with principles of inventive concepts; and

FIGS. 7A through 7H are views of an example embodiment of an endpin in accordance with principles of inventive concepts, with different rotational and leg-position configurations.

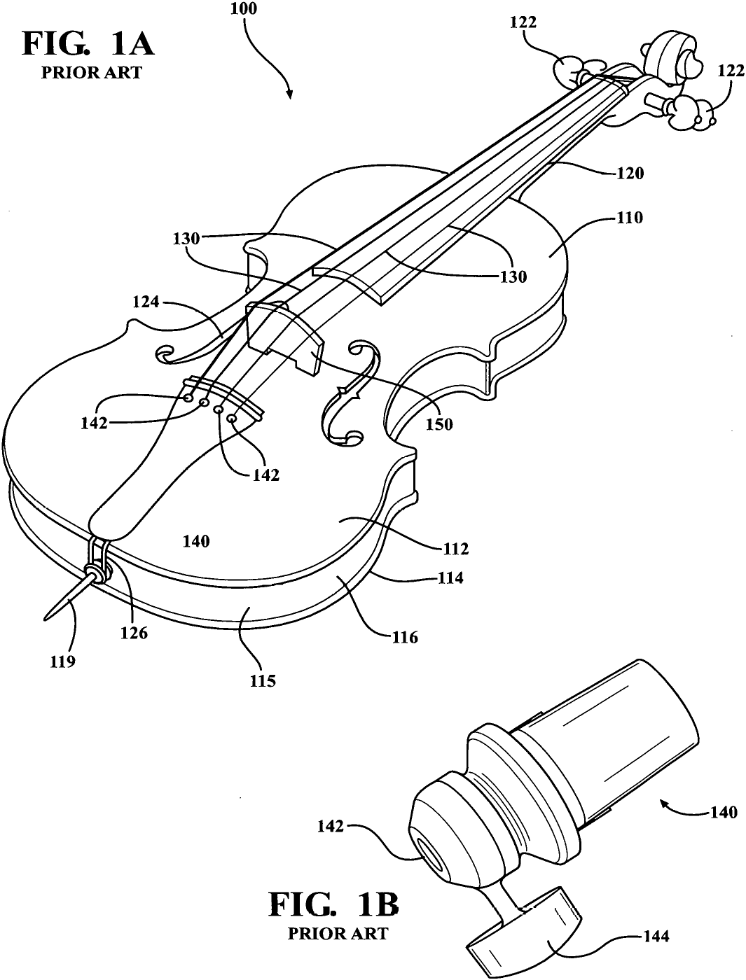

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants’ system,” “the system,” “Applicants’ method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

For clarity and brevity of description, inventive concepts may be described in terms of example embodiments related to a bass; other stringed musical instruments that employ a tailpiece are contemplated within the scope of inventive concepts.

The terms first, second, third, etc. may be used herein to describe various elements, components, regions, layers or sections. These elements, components, regions, layers or sections should not be limited by these terms. These terms may be only used to distinguish one element, component, region, step, layer or section from another region, step, layer or section. Terms such as “first,” “second,” and other numerical terms do not imply a sequence or order unless clearly indicated by the context. Thus, a first element, component, region, step, layer or section discussed below could be termed a second element, component, region, step, layer or section without departing from the teachings of the example configurations.

In example embodiments an endpin in accordance with principles of inventive concepts may include a post constructed and arranged to mate with a stringed instrument endpin collar, or plug, for attachment to the stringed instrument.

The post may define an axis, X, that, in some embodiments, is substantially orthogonal to a plane having orthogonal axes Y and Z roughly defined by the lower sidewall of the stringed instrument. Although the plane having axes Y and Z is generally coincident with the lower portion of the sidewall of the stringed instrument, some variations, some excursions from co-planarity are contemplated within the scope of inventive concepts.

In example embodiments an endpin in accordance with principles of inventive concepts may include at least one leg, which extends from a post to a contact region. The contact region is constructed and arranged to contact a supporting surface, such as a stage floor, that substantially supports the instrument as it is being played. In example embodiments the contact region may be formed to a point to penetrate, puncture, or otherwise secure the instrument to the, typically, wooden floor of the performance stage. With the endpin point penetrating and thereby securing the instrument to the venue floor, forces generated, particularly lateral forces, generated by playing the instrument are countered, thereby maintaining the position of the instrument as it is being played. In some embodiments a cap having a relatively high coefficient of friction may be used, covering or instead of, a sharp point. For example, when the instrument is to be played on a harder surface, such as concrete, a high-coefficient of friction cap may be placed over contact region having a sharpened point, or a contact region may be formed without a point and rely, instead, on a high coefficient of friction material, such as rubber, for example, to maintain the bass in position as it is played. Not wishing to be bound by theory, Applicant believes that a pointed engagement tip allows for greater freedom of movement of the instrument and thereby provides for more responsive playing of the instrument. Additionally, as will be described in the discussion related to the following figures, a pointed engagement tip may facilitate freer rotation of the endpin about its own longitudinal axis X, allowing a player to adjust an endpin to a rotational position that best suits the player. In example embodiments the endpin may be made of a metallic material, such as stainless steel or aluminum, or carbon fiber, or other material suited to support the weight of the instrument, for example. The degree of stiffness and resiliency of the endpin may be determined by the inherent characteristics of the material and thickness of the material selected and may be chosen by a performer to suit their individual preference, for example.

In example embodiments, an endpin post may be integral to an endpin leg or may be attachable to the leg, using a setscrew, threaded connection, pin, or other means. In some embodiments an endpin leg may extend to both sides of the post. In some embodiments the leg extends to only one side of the post. In some embodiments the endpin has only one contact region. In some embodiments the endpin has a plurality of contact regions. In some embodiments the post position along the leg is adjustable. In some embodiments the leg provides an indirect path from the post to a contact region. In some embodiments the path from the post to an endpin forms a cantilever path. In some embodiments the path from the post to a contact region forms an arcuate cantilever path. In some embodiments the path from the post to a contact region forms an angular engagement path. In example embodiments an endpin leg is formed in a recurve shape that connects a post to a contact region.

Not wishing to be bound by theory, Applicant believes that the recurved form, whether angular or arcuate, allows for the full amplification of vibrations set up in an instruments’ strings by bowing or plucking, the recurve contributing to the elimination, or substantial reduction, of the muting effects of a conventional straight endpin in contact with a stage floor.

A player’s comfort, the instrument’s “playability,” may be enhanced by the various adjustments offered by an endpin in accordance with principles of inventive concepts. Rotational adjustment of the endpin and leg-length adjustments allow a player to shift the center of mass of the instrument and to thereby position the weight of the instrument in a preferred orientation. In example embodiments leg-length adjustments are facilitated by a slotted leg which, in addition to the adjustment it affords, may provide for further resonance of the instrument. In example embodiments, an endpin in accordance with principles of inventive concepts provides the flexibility of having the feel of a straight endpin or one that is “bent” at any of a wide variety of angles, without any modification to the instrument itself, and to the specific preference of a given performer. Applicant experimented with rotating the shaft in the endpin collar, also referred to herein as a plug, and the weight of the instrument was shifted in different ways, providing a different feel for each position. With an adjustable leg, which may be implanted using a slotted spine, or leg, a player may freely change angles and balance the instrument in a variety of ways to suit the player’s optimum playing position. Additionally, a player may adjust example embodiments of an endpin in accordance with principles of inventive concepts so that the endpin has one contact point or multiple contact points with a stage.

In example embodiments in accordance with principles of inventive concepts, an endpin in accordance with principles of inventive concepts may support the instrument’s body while the instrument is being played and may provide superior performance and playability.

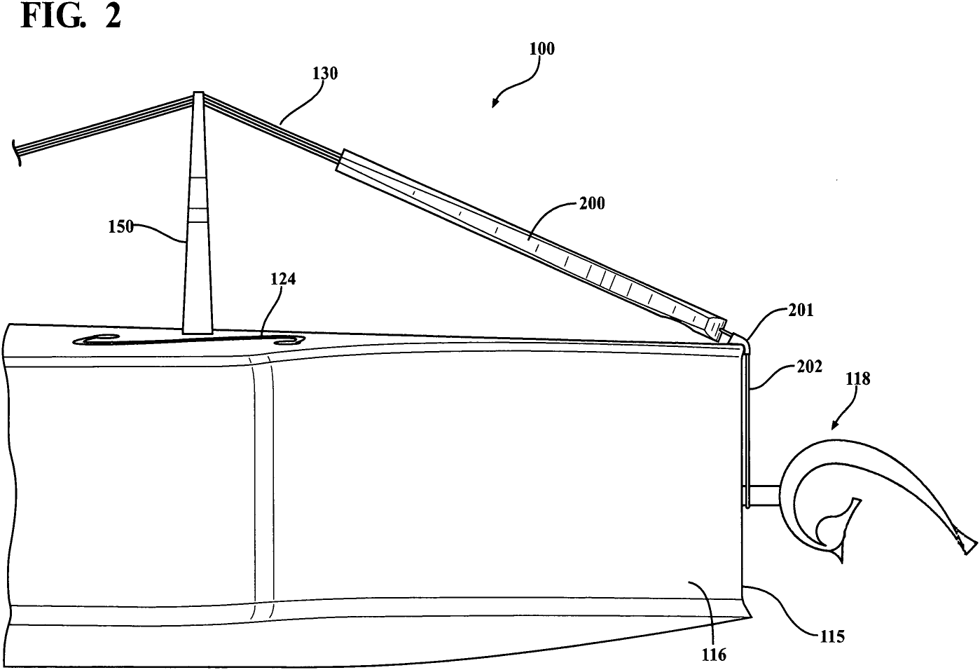

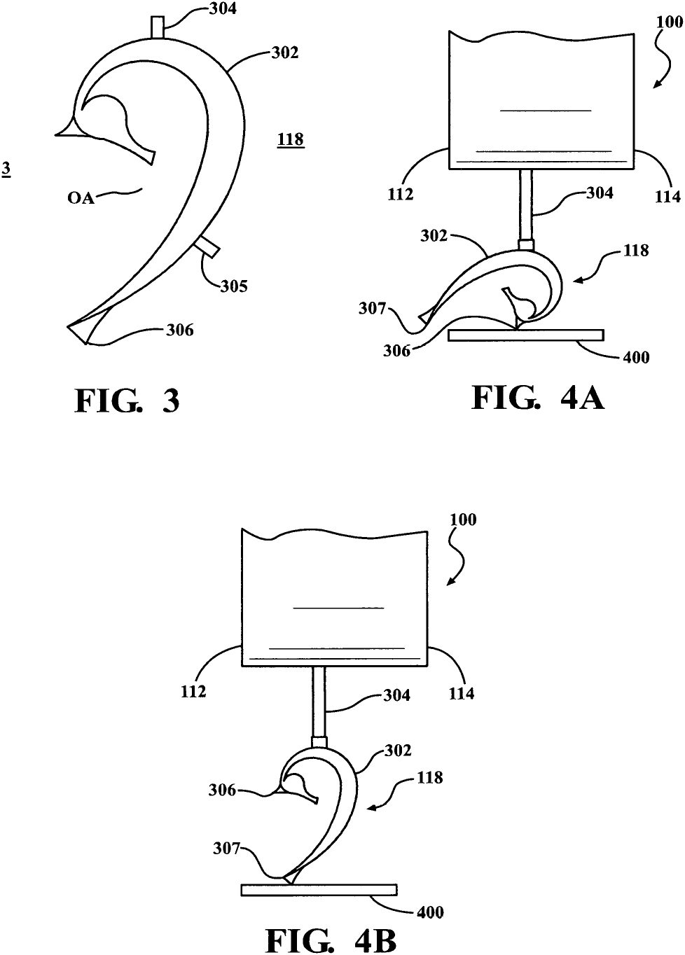

An example embodiment of an apparatus and method for a stringed musical instrument endpin 118 is depicted, generally, in FIGS. 2 and 3, in which example embodiment a tailpiece 200 attaches strings 130 of a violin family instrument 100 through tailgut 202, which crosses saddle 201, to endpin 118. Bridge 150, rib 116, lower rib 115 and f hole 124 are as previously described. As will be described in greater detail in the discussion related to FIG. 3 through FIG. 7H, in example embodiments the overall contour of endpin 118 may be recurved, with an arced or angular opening described by a leg 302 that connects post 304 and at least one contact region 306. The post 304/ is constructed and arranged for insertion within the lower rib 115 of the instrument and may be secured within a collar, or plug 140, there by a set screw 144, for example.

In example embodiments endpin 118 may employ a recurve-shaped leg 302. Not wishing to be bound by theory, Applicant believes that, somewhat similar to the action of a running blade, the recurve shape preserves energy produced by a player bowing or plucking the instrument strings and provides for a fuller, more resonant sounding instrument. Although running blades are generally made of a flexible carbon fiber material, Applicant’s endpin design accommodates many materials including aluminum, stainless steel, and carbon steel, for example. By recurve we mean, as in the dictionary definition, that an endpin in accordance with principles of inventive concepts includes a leg or a portion of a leg that curves, or extends, in one direction, then turns back, “recurves,” in the opposite direction. The leg, and its associated curve, may be arcuate, with a relatively smooth recurve, or may be angular, with a sharper, more abrupt, recurve. Legs with a plurality of arcuate and/or angular segments are contemplated within the scope of inventive concepts. A recurve leg in accordance with principles of inventive concepts may define between the two ends of the leg an area that may be of any degree of shallowness or depth,

Turning now to FIG. 3, an example embodiment of an endpin 118 in accordance with principles of inventive concepts includes a leg 302, a post 304 (two posts 304 and 305 in this example embodiment), and a contact region 306 (two contact regions 306 and 307in this example embodiment). The leg 302 defines a partially open area OA, which, on a closed side, follows the contour of the inside, or closed side, of leg 302. Because, in example embodiments, the leg 302 may exhibit a smooth arc (as shown in FIG. 3) or an angular line defining the inside of leg 302 the partially open area OA may also exhibit either an arcuate or angular corresponding closed side. In this example embodiment two fixed posts 304 and 305 are illustrated, but embodiments with fewer or a greater number of posts are contemplated within the scope of inventive concepts. Similarly, two contact regions 306 and 307 are illustrated, but embodiments with fewer or a greater number of contact regions are contemplated within the scope of inventive concepts. Although leg 302 extends to either side of posts 304 in this example embodiment, embodiments in which leg 302 does not extend beyond post 304 are contemplated within the scope of inventive concepts. As will be described in greater detail below, although posts 304 and 305 are fixed in this example embodiment, one or more posts may be adjustable, configured to move along the leg 302, through a slot for example, in order to adjust the position of a post 304 and, correspondingly, endpin 118 according to the desires of an individual performer.

The side view of FIG. 4A illustrates an instrument 100 with an endpin 118 in accordance with principles of inventive concepts attached through post 304. For clarity, the instrument is illustrated resting on a performance surface 400, such as a performance hall’s wooden floor. In the view of FIG. 4A, one can see that a contact region 306 is engaged with the performance surface 400. and in the view of FIG. 4B, and contact region 306 on a longer portion of leg 302 is engaged with the performance surface 400. Contact region 307 may also engage with performance surface 400, depending upon the exact location of post 304 with respect to contact regions 306 and 307. Any given performer may prefer a different orientation, as the different configurations may shift the center of mass of the instrument 100 to suit the performer’s preference. In the view of FIG. 4B, contact region 307 engages with performance surface 400. In this example embodiment leg 302 exhibits a recurve that is arcuate with the arc tightening at one end, the end, in this view, closest to post 304.

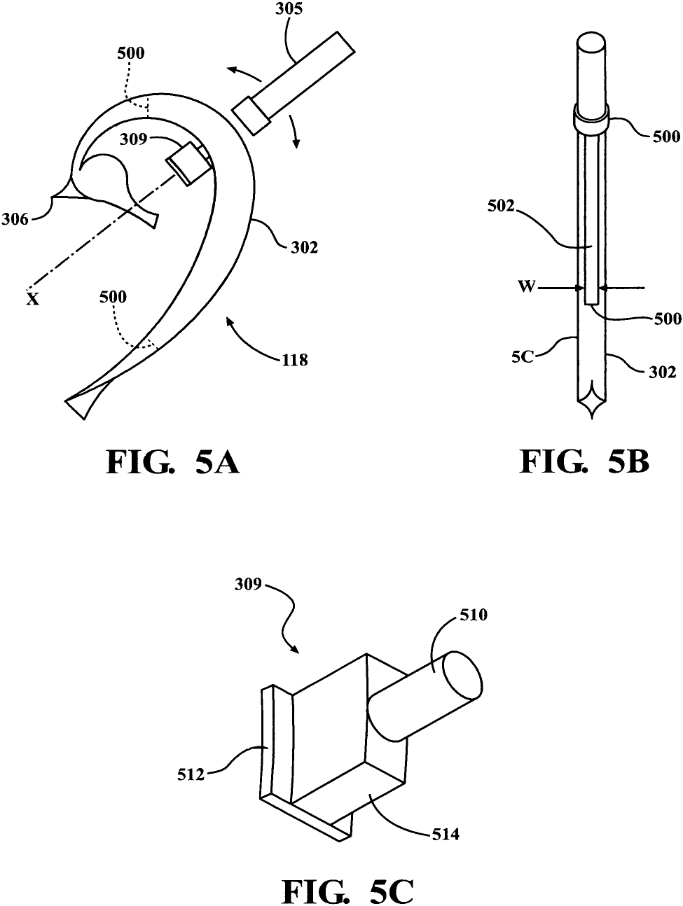

Turning now to FIGS. 5A, 5B and 5C, an example embodiment of an adjustable endpin in accordance with principles of inventive concepts will be described. In an example embodiment endpin 118 includes two contact regions 306 and 307 as previously described and a slotted leg 302 constructed and arranged to receive adjustment post 305 and mating bolt 309. In the example embodiments, such as those of FIGS. 5A, 5B, and 5C, contact regions, such as regions 306 and 307, provide a point for contact and penetration with a playing surface 400, as previously described. As will be described in greater detail below, bolt 309 and adjustment post 305 may be joined, through a threaded joint for example, and tightened in position anywhere along the slotted portion of leg 302, allowing a performer to adjust the post location along the length of the leg 302. The slotted portion of the leg is delineated by broken lines 500 in FIG. 5A and solid lines 500 in FIG. 5B. Slot width w is sufficient to snugly accommodate the movement of mating bolt 309 without so much margin as to allow the mating member to set up unwanted vibrations and noise in sympathy with the motion of the instrument’s strings while it is being played. FIG. 5B illustrates the slot 502 formed within leg 302 of endpin 118. ///Chris, give an example slot and mating member widths///. Such an adjustment allows a performer to shift the center of mass of the instrument to a playing position that best suits the performer. That is, in example embodiments axis X, which is coaxial with the longitudinal axis (i.e., an axis along the length of the post) post 305, projects toward the center of mass of instrument 100 in fixed relationship with the center of mass and as the position of post 305 is adjusted along the slot 502 the position of the intersection of axis X relative to contact region 306 on a playing surface 400 is varied, as is, correspondingly, the relative position of the instrument’s center of mass. The perspective drawing of FIG. 5C illustrates an example embodiment of a bolt 309, which includes a threaded section 510, a slot body 514, and a flange 512. The threaded section 510 is constructed and arranged to mate with a threaded section of post 305. Slot body 514 is configured to fit in and glide along slot 502 while the bolt 307/post 305 combination is being positioned. Flange 512 is configured to be forced against an edge, for example inside edge, of leg 302 when the bolt 307/post 305 combination is tightened to hold the post 305 in place along the slot 502 and to thereby secure the endpin 118 in a selected position relative to instrument 100.

In example embodiments endpin 118 may employ a recurve-shaped leg 302, as previously described.

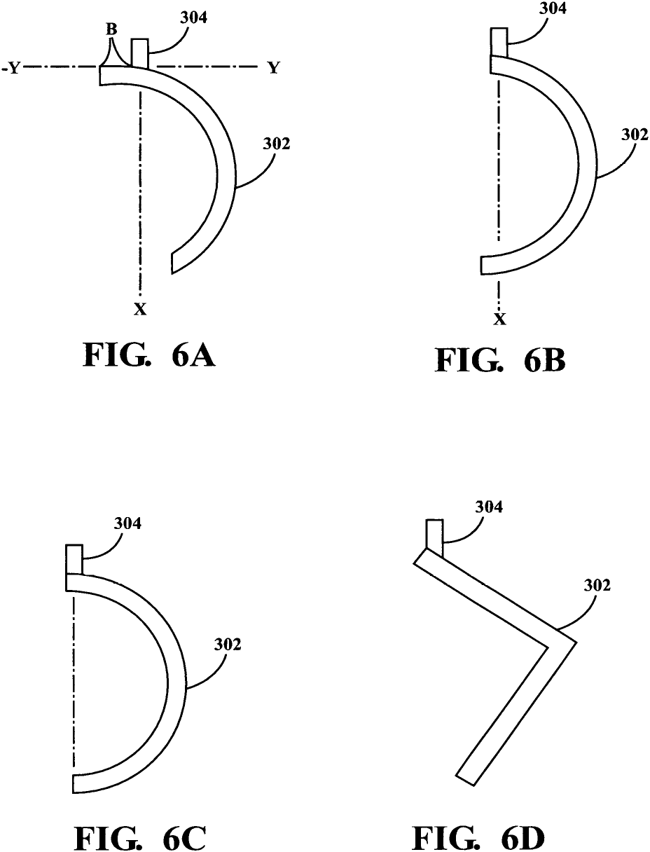

FIGS. 6A, 6B, 6C and 6D provide examples of arcuate leg, arcuate leg, arcuate leg, and angular leg recurved embodiments in accordance with principles of inventive concepts, respectively. In the example embodiment of FIG. 6A endpin leg 302 is arcuate in form, with leg 302 extending from post 304 (with its central longitudinal axis defining the X axis), first in a positive Y direction, then gradually arcing, or turning, back, in some embodiments as far as in the negative Y direction. The end of leg 302 closest the instrument may be referred to herein as the post end and the end farthest from the instrument may be referred to herein as the contact end. In example embodiments, the contact end may extend back beyond the X axis, just to the X axis, or short of the X axis. The post end of the leg may extend just to the post 304 (with sufficient overlap to support the instrument) or beyond the post, as illustrated by segment B of FIG. 6A. Contact end may include a contacting surface configured to provide non-skid contact with a performance surface, such as a knurled surface, a rubberized surface, a non-skid (e.g., rubberized or tacky) cap, or, as illustrated in various embodiments herein, a hard, pointed, contact configured to penetrate a playing surface such as a wooden floor and to thereby secure the instrument for a performer. In the example embodiment of FIG. 6B the post end of leg 302extends to and just the width of post 304 and contact end returns to a position beyond that of the X axis (that is, beyond a projection of the central axis of post 304. An example angular, or angular-leg, embodiment of an endpin 118 in accordance with principles of inventive concepts is shown in FIG. 6D. In this example embodiment the upper portion of leg 302 extends in a line in the positive Y direction then abruptly returns to the negative Y direction in the lower leg portion, forming an acute angle between upper and lower leg portions. As will be described in greater detail below, post 304 may be attached to an instrument in any of a variety of orientations rotated about axis X, thereby allowing a performer to adjust the playing position of the instrument. With the position of the post along the leg adjustable, as described in the discussion related to example slotted-leg embodiments, with the ability to flip ends to select a contact end for use, and the ability to rotate the endpin 118 to a desired position, a performer is afforded a great deal of adjustment capability, allowing them to adjust the instrument for maximum playing comfort.

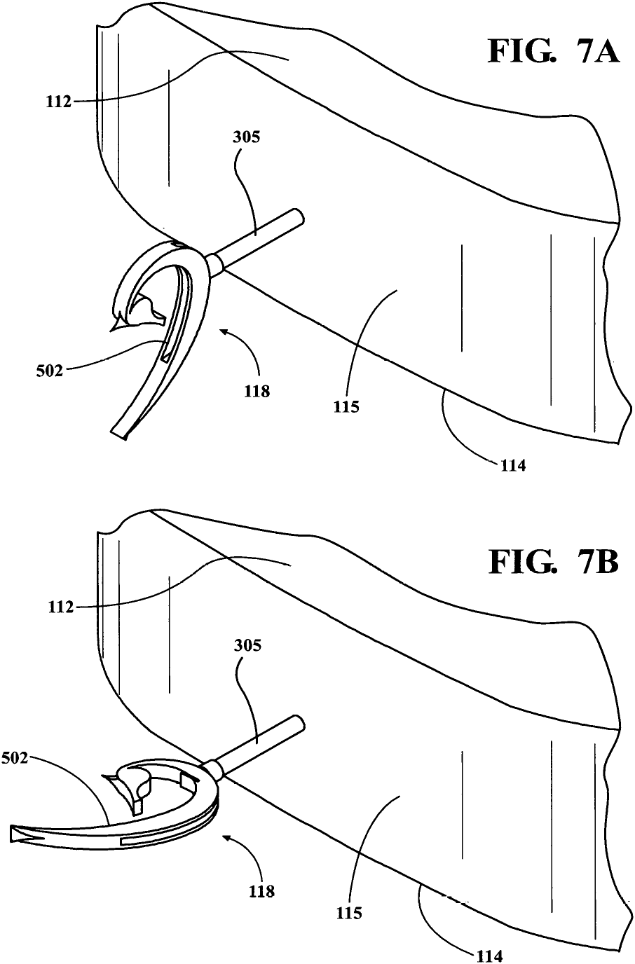

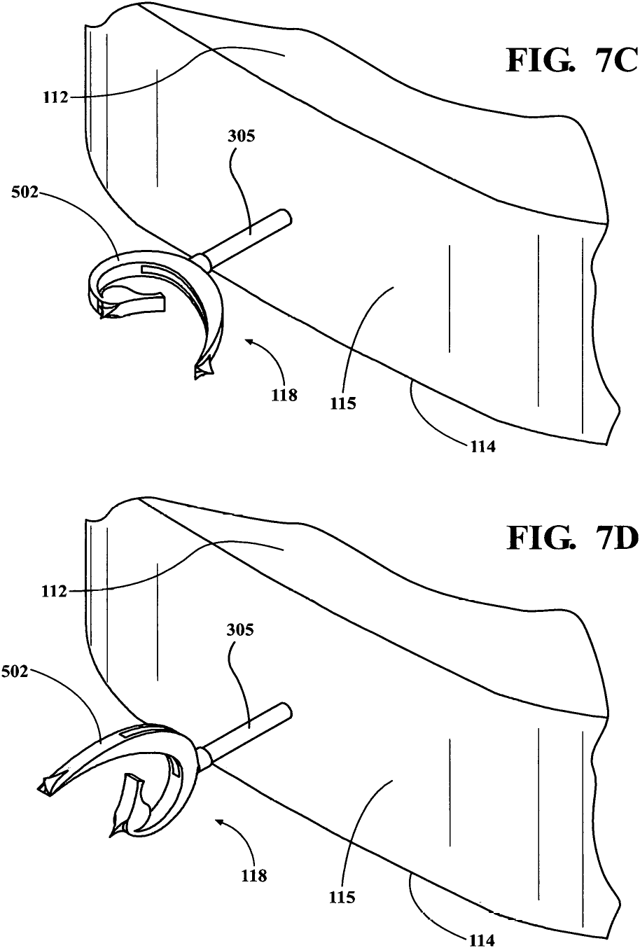

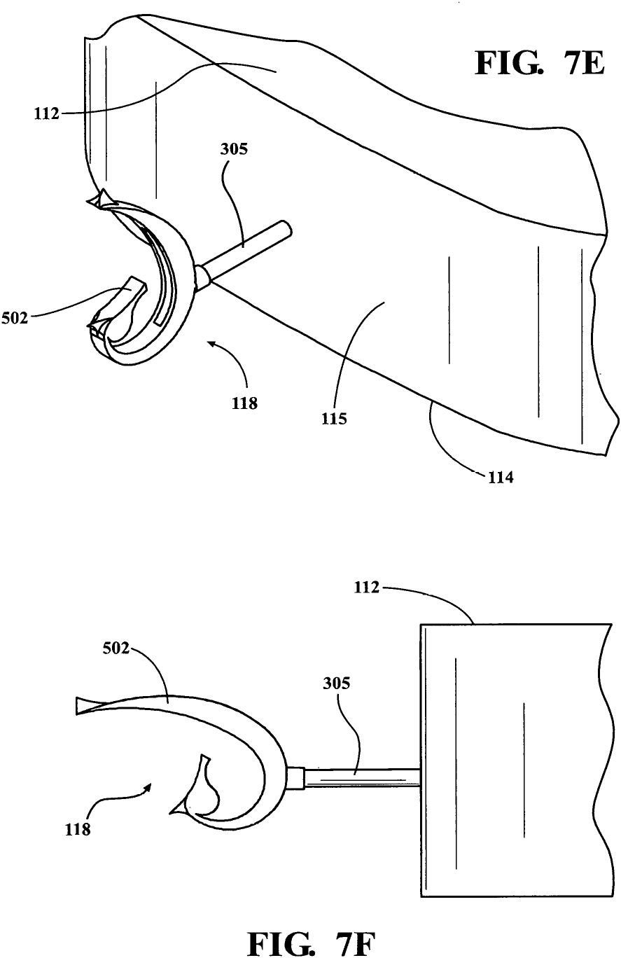

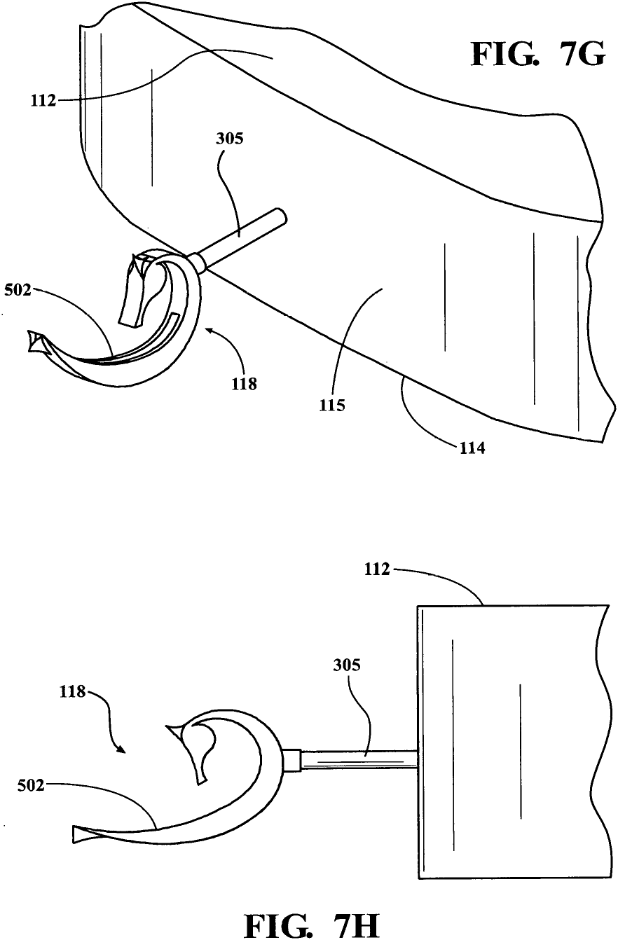

FIGS. 7A through 7I illustrate example embodiments of an endpin 118 in accordance with principles of inventive concepts positioned in various orientations with respect to a stringed instrument, 100. In the illustrative examples the endpin is rotated around the axis X of the post 305. As previously described, a performer may rotate and fix the endpin 118 in this manner to position the instrument to best suit a preferred playing position. By adjusting the position of the post 305 along the slot 502, a performer may further adjust the playing position of the instrument 100. In the example embodiment of FIG. 7A, the endpin 118 is oriented such that its sides generally define a plane that is perpendicular to the planes generally defined by the top 112 and back 114 of the instrument 100. By “generally define” we acknowledge that the top and/or back may, in fact be arched and that, therefore, the plane “generally defined” would be an approximation. In any case, since the endpin may be positioned in any orientation around the axis, X, the use of the term “perpendicular to the planes” is used merely for descriptive clarity. In the illustrative embodiment of FIG. 7A, endpin 118 is shown with two contact ends or regions, one at each end of the leg and with the post 305 situated toward the “upper” extreme of slot 502, “upper extreme” referring to the end of the slot nearest the shorter, more tightly-wound portion of leg 302. In FIG. 7B the endpin is rotated ninety degrees with respect to the orientation of FIG. 7A. In FIG. 7C, the endpin is rotated to the same degree as that of the illustrative embodiment of FIG. 7B, but the post 305 is positioned at a different, lower, position within slot 502. In this configuration, in example embodiments, both contact points of endpin 118 may engage with a performance center’s floor while the instrument is being played. In the illustrative embodiment of FIG. 7D the endpin 118 is rotated one hundred and eighty degrees from the orientation of FIG. 7A and in FIG. 7E, the endpin 118 is rotated to the same degree as in FIG. 7D, but post 305 is positioned within slot 502 similar to the positioning of FIG. 7C. FIG. 7F provides a side view of endpin 118, oriented as in FIG. 7D. In the illustrative embodiment of FIG. 7G, endpin 118 is shown with two contact ends, one at each end of the leg 302 and with the post 305 situated at the “upper” extreme of slot 502, “upper extreme” referring to the end of the slot nearest the shorter, more tightly-wound portion of leg 302, and FIG. 7H provides a side view of the endpin 118 positioned as in FIG. 7G.

Not wishing to be bound by theory, Applicant believes that the cantilever, or recurve, form, whether angular or arcuate, allows for the full amplification of vibrations set up in an instruments’ strings by bowing or plucking, the cantilever contributing to the elimination, or substantial reduction, of the muting effects of a conventional straight endpin in contact with a stage floor.

A player’s comfort, the instrument’s “playability,” may be enhanced by the various adjustments offered by an endpin in accordance with principles of inventive concepts. Rotational adjustment of the endpin and leg-length adjustments allow a player to shift the center of mass of the instrument and to thereby position the weight of the instrument in a preferred orientation. In example embodiments leg-length adjustments are facilitated by a slotted leg which, in addition to the adjustment it affords, may provide for further resonance of the instrument. In example embodiments, the endpin provides the flexibility of having the feel of a straight endpin or one that is “bent” at any of a wide variety of angles, without any modification to the instrument itself. Applicant experimented with rotating the shaft in the endpin collar, and the weight of the instrument was shifted in different ways, providing a different feel for each position. With an adjustable leg, or slotted spine, a player may freely change angles and balance the instrument in a variety of ways to suit the player’s optimum playing position. A player may adjust the endpin so that the tip of the endpin has one contact point or multiple contact points.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A musical instrument endpin, comprising:
a post configured to engage a stringed instrument through the instrument’s sidewall; and
a recurved leg configured to conduct forces from the post to a supporting surface.

2. The endpin of claim 1, wherein the post engages the stringed instrument through an endpin collar located in the instrument’s sidewall.

3. The endpin of claim 2, wherein the endpin is configured to be rotatably adjustable about an axis defined by centerline of the post.

4. The endpin of claim 1, wherein the post is integral to the recurved leg.

5. The endpin of claim 1, wherein the post is attachable to the recurved leg.

6. The endpin of claim 5, wherein the post is configured to be adjustable in position along the recurved leg.

7. The endpin of claim 6, wherein the recurved leg includes a slot for receiving the post.

8. The endpin of claim 1, wherein the leg includes a contact region for contact with a supporting surface.

9. The endpin of claim 8, wherein the leg includes a plurality of contact regions for contact with a supporting floor.

10. The endpin of claim 8, wherein the contact region includes a non-skid surface.

11. The endpin of claim 8, wherein the contact region is configured for penetration of the supporting surface.

12. The endpin of claim 1, wherein the recurved leg includes a plurality of recurved regions.

13. The endpin of claim 1, wherein the recurve region is arcuate.

14. The endpin of claim 1, wherein the recurve region is angular.

15. The endpin of claim 1, wherein the recurve region is a combination of arcuate and angular regions.

16. A stringed instrument, comprising:
a top plate;
a bottom plate;
ribs; and
an endpin including:
a post configured to engage a stringed instrument through the instrument’s rib; and
a recurved leg configured to conduct forces from the post to a supporting surface.

17. The instrument of claim 16, wherein the post engages the stringed instrument through an endpin collar located in the instrument’s rib.

18. The instrument of claim 17, wherein the endpin is configured to be rotatably adjustable about an axis defined by centerline of the post.

19. The instrument of claim 16, wherein the post is attachable to the recurved leg.

20. The instrument of claim 19, wherein the post is configured to be adjustable in position along the recurved leg.
